(19) United States
(12) Patent Application Publication
(10) Pub. No.: US 2010/0175138 A1
(43) Pub. Date: Jul. 8, 2010

(54) SYSTEM AND METHOD FOR PROVIDING CONTENT FOR DIGITAL RIGHTS MANAGEMENT

(75) Inventors: Byung Rae LEE, Seoul (KR); Sung Oh Hwang, Yongin-si (KR); Seleznev Sergey, Suwon-si (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/652,438

(22) Filed: Jan. 5, 2010

(30) Foreign Application Priority Data
Jan. 5, 2009 (KR) 10-2009-0000279

(51) Int. Cl. G06F 21/00

(52) U.S. Cl. 726/30

(57) ABSTRACT

A method of providing DRM content, including transmitting, by a content issuer, when a request for a specific main content of a communication terminal is input, a DRM content including the main content and a preset sub-content corresponding to the main content to the communication terminal; transmitting, by a rights issuer, a rights object having constraint condition information for securing reproduction of the sub-content to the communication terminal; and reproducing, by the communication terminal, when the DRM content and the rights object are received, the sub-content by analyzing the rights object and reproducing, when reproduction of the sub-content is complete, the main content. Reproduction of a sub-content in a communication terminal can be secured through constraint condition information of a rights object, and waste of resources required for providing a sub-content can be suppressed.

### PRIORITY

This application claims priority to an application entitled “SYSTEM AND METHOD FOR PROVIDING CONTENT FOR DIGITAL RIGHTS MANAGEMENT” filed in the Korean Intellectual Property Office on Jan. 5, 2009 and assigned Serial No. 10-2009-0000279, the content of which are hereby incorporated by reference.

### BACKGROUND OF THE INVENTION

1. Field of the Invention

The present invention relates to a communication system and a method of operating the same, and more particularly, to a system and method for providing content for Digital Rights Management (DRM).

2. Description of the Related Art

In general, DRM technology is technology for safely protecting and systematically managing rights for digital content. Unlike analog content, digital content can be reproduced without loss and can be easily reused, processed, and distributed. Digital content is manufactured with relatively many resources, but can be copied and distributed with minimal cost and effort. Thus, the importance of DRM and an application range of the DRM technology increases.

In a communication system to which DRM technology is applied, a content provider provides digital content to a content user. However, in such a communication system, a content provider can provide a plurality of digital content regardless of a content user's request. For example, a content provider can provide advertisement content together with content requested by a content user. In this case, when the content user refuses to use the advertisement content, resources required for providing advertisement content are wasted in the communication system.

### SUMMARY OF THE INVENTION

The present invention has been made to solve at least the above problems, and provides a system and method for providing content for DRM.

In accordance with an aspect of the present invention, a method of providing DRM content includes transmitting, by a Content Issuer (CI), when a request for a specific main content of a communication terminal is input, the DRM content including main content and a preset sub-content corresponding to the main content to the communication terminal; transmitting, by a Rights Issuer (RI), a rights object having constraint condition information for securing reproduction of the sub-content to the communication terminal; and reproducing, by the communication terminal, when the DRM content and the right object are received, the sub-content by analyzing the rights object and reproducing, when reproduction of the sub-content is complete, the main content.

In accordance with another aspect of the present invention, a DRM content providing system includes a CI for storing a DRM content including a main content and a sub-content corresponding to the main content and for transmitting, when a request for the main content is input, the DRM content; a RI for storing a right object having constraint condition information for securing reproduction of the sub-content in the DRM content and for transmitting, when a request for the right object is input, the right object; and a communication terminal for reproducing, when the DRM content and the right object are received, the sub-content by analyzing the right object and for reproducing, when reproduction of the sub-content is complete, the main content.

### BRIEF DESCRIPTION OF THE DRAWINGS

The objects, features and advantages of the present invention will be more apparent from the following detailed description in conjunction with the accompanying drawings, in which:

FIG. 1 is a diagram illustrating a configuration of a DRM content providing system according to an embodiment of the present invention;

FIG. 2 is a flowchart illustrating a signal flow when performing a method of providing a DRM content according to another embodiment of the present invention;

FIGS. 3 to 9 are structural diagrams illustrating an XML schema of a right object of a DRM content in the method of FIG. 2;

FIG. 10 is a block diagram illustrating a configuration of a communication terminal in the DRM content providing system of FIG. 1;

FIG. 11 is a flowchart illustrating a process of providing a DRM content of the communication terminal of FIG. 10; and

FIG. 12 is a flowchart illustrating a process of reproducing a DRM content in the DRM content providing process of FIG. 11.

### DETAILED DESCRIPTION OF EXEMPLARY EMBODIMENTS

Hereinafter, embodiments of the present invention are described in detail with reference to the accompanying drawings. The same reference numbers are used throughout the drawings to refer to the same or like parts. Detailed descriptions of well-known functions and structures incorporated herein may be omitted to avoid obscuring the subject matter of the present invention.

In the following description, a term “DRM content” is digital content protected and managed through DRM technology in a communication system. The DRM content is formed with at least one digital content. A term “main content” is digital content essentially formed in the DRM content. That is, the main content is formed as at least part of the DRM content. The main content is formed with at least one of text data, image data, and audio data. The main content may be, for example a picture, a moving picture, or a Moving Picture experts group-1 audio layer 3 (MP3) file. A term “sub-content” is a digital content selectively formed for the DRM content. The sub-content is a part of the DRM content together with the main content but may not be a part of the DRM content. Here, the sub-content may be formed with at least one of text data, image data, and audio data. The sub-content may be an advertisement content, for example a picture, a moving picture, and an MP3 file, derived from a specific main content.

A term “rights object” is a license required when using a specific digital content. The rights object is essentially required when using a specific digital content. When the DRM content is formed with a sub-content and a main content, the rights object includes constraint condition information for sequentially reproducing the sub-content and the main content.

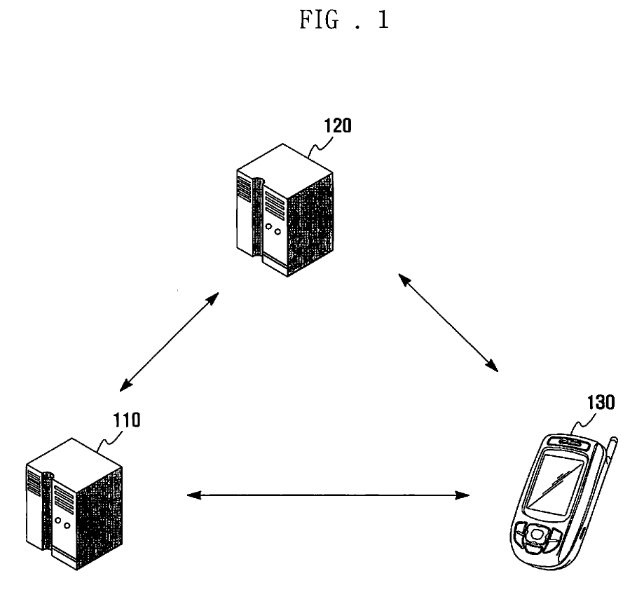

FIG. 1 is a diagram illustrating a configuration of a DRM content providing system according to an embodiment of the present invention.

The DRM content providing system is based on Open Mobile Alliance (OMA) DRM (OMA DRM) standard technology.

Referring to FIG. 1, the DRM content providing system according to the present embodiment includes a CI 110, an RI 120, and communication terminal 130.

The CI 110 supplies DRM content. The CI 110 cryptographs digital content to generate and store DRM content. For example, the CI 110 stores the DRM content as a DRM Content Format (DCF) prescribed in OMA-TS-DRM-DCF-V2_{—}0-200060303-A specification. In the present embodiment, the CI 110 stores a main content and a sub-content and stores the sub-content to correspond to the main content. For example, the CI 110 stores a DRM content formed with a specific main content and a sub-content corresponding thereto as a multipart DCF. When the communication terminal 130 accesses a specific DRM content, the CI 110 transmits the DRM content to the communication terminal 130. In the present embodiment, when the communication terminal 130 accesses a specific main content, the CI 110 determines whether a sub-content corresponds to the main content. If a sub-content corresponds to the main content, the CI 110 transmits a DRM content including the main content and the sub-content to the communication terminal 130.

The RI 120 supplies a rights object on a DRM content basis. The RI 120 stores a rights object for decoding DRM content. In this case, the RI 120 may store a rights object on a main content basis and on a sub-content basis. In the present embodiment, when the DRM content is formed with a main content and a sub-content, the RI 120 stores a rights object for each DRM content having constraint condition information for sequentially reproducing the sub-content and main content. Further, when the communication terminal 130 accesses a rights object of a specific DRM content, the RI 120 transmits a rights object of the DRM content to the communication terminal 130. In the present embodiment, when the communication terminal 130 accesses a rights object of a specific main content, the RI 120 determines whether a sub-content corresponds to the main content. If a sub-content corresponds to the main content, the RI 120 transmits a rights object of a DRM content including the main content to the communication terminal 130.

The communication terminal 130 accesses the CI 110 and the RI 120 and acquires a DRM content and a rights object of the DRM content. When the DRM content and the rights object of the DRM content are bought by a user of the communication terminal 130, the communication terminal 130 acquires the DRM content and the rights object of the DRM content. In this case, if the DRM content is acquired and the rights object of the DRM content is not acquired, the communication terminal 130 cannot decode the DRM content. Thereby, the communication terminal 130 cannot use the DRM content without the rights object. When the DRM content is shared, the communication terminal 130 can acquire the DRM content separately from the CI 110, but should access the RI 120 in order to use the DRM content.

The communication terminal 130 reproduces a DRM content by analyzing a rights object of the DRM content. That is, the communication terminal 130 decodes the DRM content using a rights object and reproduces the DRM content. When the DRM is formed with a main content and a sub-content, the communication terminal 130 sequentially reproduces a sub-content and a main content. Specifically, the communication terminal 130 reproduces a sub-content according to constraint condition information of a rights object and reproduces, when reproduction of the sub-content is complete, a main content.

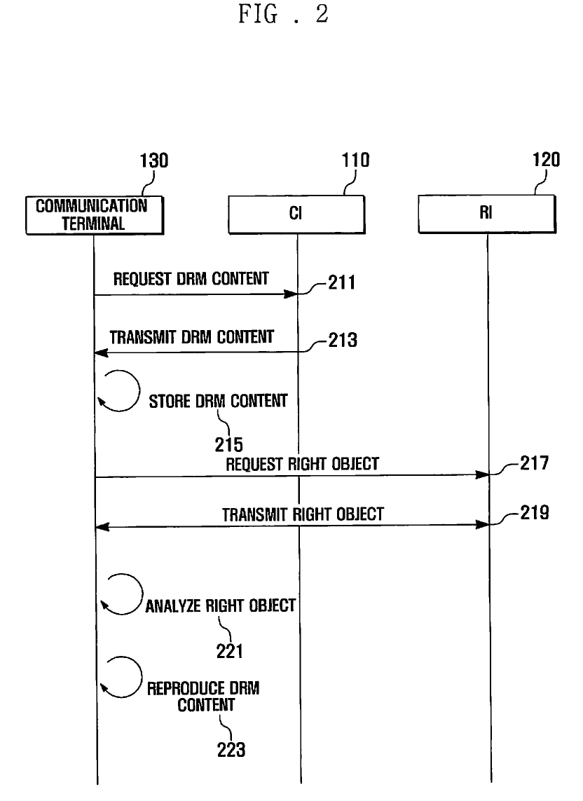

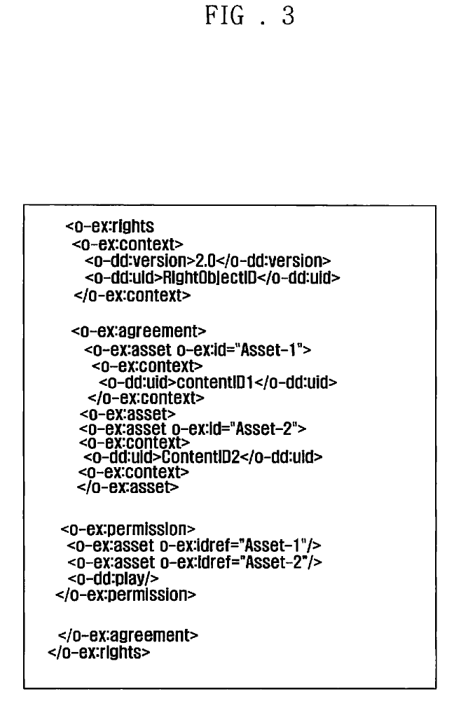

FIG. 2 is a flowchart illustrating a signal flow when performing a method of providing a DRM content according to another embodiment of the present invention. FIGS. 3 to 9 are structural diagrams illustrating an XML schema of a rights object of a DRM content in the method of FIG. 2.

Referring to FIG. 2, the communication terminal 130 requests a DRM content to the CI 110 in step 211. In this case, the communication terminal 130 can request a specific main content.

When a DRM content is requested to the CI 110, the CI 110 searches for the DRM content and transmits the DRM content to the communication terminal 130 in step 213. In this case, when a specific main content is requested, if a sub-content corresponds to the main content, the CI 110 transmits a DRM content including the main content and the sub-content.

When the DRM content is received, the communication terminal 130 stores the DRM content in step 215.

The communication terminal 130 requests a rights object of the DRM content to the RI 120 in step 217. In this case, the communication terminal 130 can request a rights object of a specific main content.

When a right object of a specific DRM content is requested, the RI 120 searches for a rights object of the DRM content and transmits the rights object to the communication terminal 130 in step 219. In this case, when a rights object of a specific main content is requested, if a sub-content corresponds to the main content, the RI 120 transmits a rights object of the DRM content including the main content and the sub-content. For example, as shown in FIG. 3, the right object represents that the DRM content is formed with a main content and a sub-content. In this case, the rights object includes a context element including a background, for example a version and an identifier (e.g., RightsObjectID) of the rights object, an agreement element including an identifier of a sub-content and a main content, and a permission element for permitting reproduction of a sub-content and of a main content. Here, ‘Asset-1’ is a content name of a sub-content having an intrinsic identifier ‘ContentID1’, and ‘Asset-2’ is a content name of a main content having an intrinsic identifier ‘ContentlD2’. That is, the rights object represents that a sub-content and a main content can be reproduced in the communication terminal 130 through a permission element.

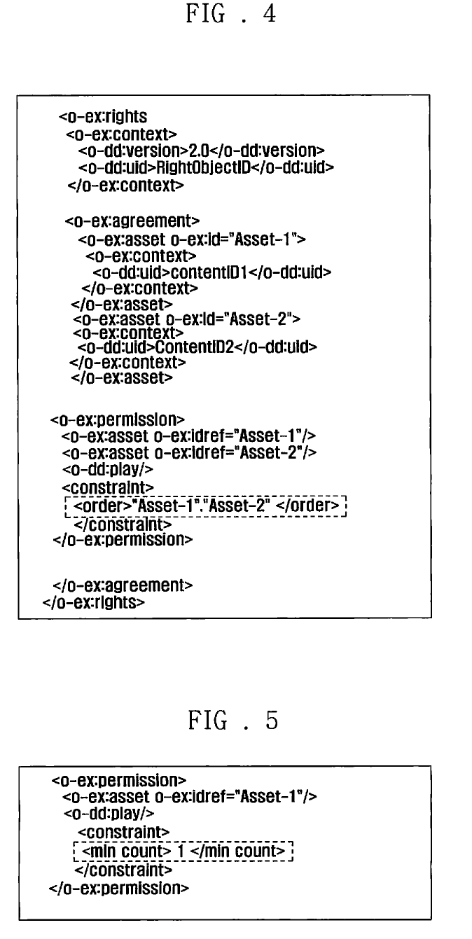

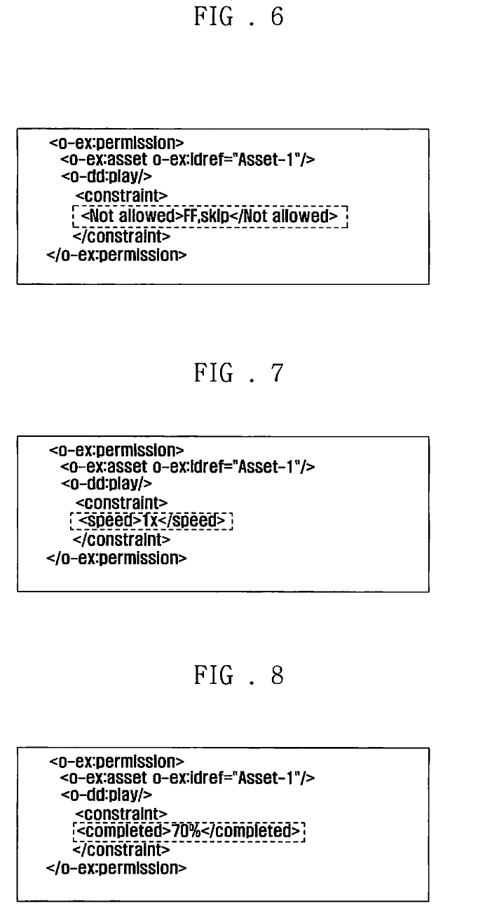

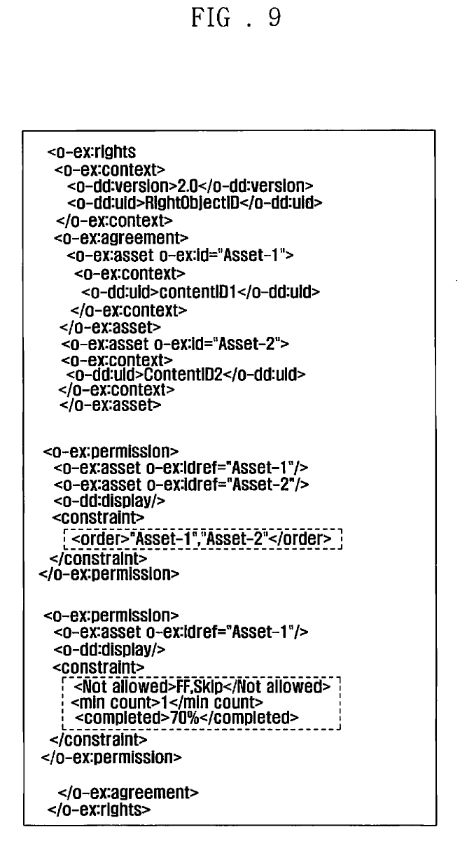

As shown in FIG. 4, the rights object includes constraint condition information “constraint” for securing reproduction of a sub-content together with the main content. That is, the rights object includes constraint condition information for limiting a reproduction order of a sub-content and a main content in the communication terminal 130 in the permission element. In this case, as shown in FIG. 5, the constraint condition information further includes the constraint “min count” for limiting the number of times that a sub-content in the communication terminal 130 should be reproduced. As shown in FIG. 6, the constraint condition information further includes constraint “Not allowed” for limiting a reproduction speed of a sub-content in the communication terminal 130. Further, as shown in FIG. 7, the constraint condition information further includes a constraint “speed” for limiting a reproduction speed of a sub-content in the communication terminal 130. In addition, as shown in FIG. 8, the constraint condition information further includes a constraint “completed” for limiting a reproduction determination reference of a sub-content in the communication terminal 130.

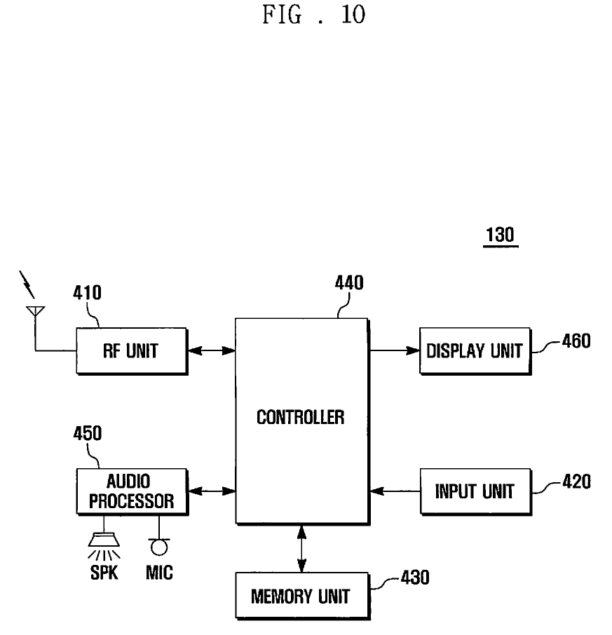

When a right object of the DRM content is received, the communication terminal 130 analyzes the rights object in step 221 and reproduces the DRM content in step 223. When the DRM content is formed with a main content and a sub-content, the communication terminal 130 sequentially reproduces the sub-content and the main content. That is, the communication terminal 130 reproduces a sub-content according to the constraint condition information of the rights object, and when reproduction of a sub-content is complete, the communication terminal 130 reproduces the main content. For example, as shown in FIG. 9, when the right object includes constraint “Not allowed”, the constraint “min count”, and the constraint “completed”, the communication terminal 130 should reproduce more than 70% of the sub-content at least one time without changing a reproduction speed and reproduce the main content. In other words, when a sub-content is reproduced, the communication terminal 130 disregards a fast forward (FF) or skip request.

FIG. 10 is a block diagram illustrating a configuration of the communication terminal 130 in the DRM content providing system of FIG. 1.

In the present embodiment, the communication terminal 130 is a mobile phone.

Referring to FIG. 10, the communication terminal 130 according to the present embodiment includes a Radio Frequency (RF) unit 410, an input unit 420, a memory unit 430, a controller 440, an audio processor 450, and a display unit 460.

The RF unit 410 performs a communication function of the communication terminal 130. The RF unit 410 includes an RF transmitter for up-converting a frequency of a signal to be transmitted and amplifying the signal, and an RF receiver for low-noise amplifying a received signal and down-converting a frequency of the signal.

The input unit 420 includes keys for inputting numeral and character information and function keys for setting various functions. The input unit 420 may be formed with, for example, a keypad, a jog dial, a touch pad, and/or a joy stick.

The memory unit 430 includes a program memory and a data memory. The program memory stores programs for controlling general operations of the communication terminal 130. In the present embodiment, the program memory stores programs for providing DRM content. The data memory performs a function of storing data generated while performing programs.

The controller 440 performs a function of controlling general operations of the communication terminal 130. The controller 440 includes a data processor including a transmitter for encoding and modulating a signal to be transmitted and a receiver for demodulating and decoding a received signal. The data processor includes a modem and a codec. The codec includes a data codec for processing packet data and an audio codec for processing an audio signal such as sound. In the present embodiment, the controller 440 can be operated with a DRM agent. That is, in the present embodiment, the controller 440 performs a content reproduction mode. In this case, the controller 440 accesses the CI 110 and the RI 120 through the RF unit 410 to acquire a DRM content and a rights object of the DRM content. Further, the controller 440 can store the DRM content in the memory unit 430. In addition, the controller 440 analyzes a rights object to reproduce the DRM content.

The audio processor 450 performs a function of reproducing an audio signal output from the audio codec of the data processor through a speaker SPK, or transmitting an audio signal generated in a microphone MIC to the audio codec of the data processor.

The display unit 460 displays user data output from the controller 440. The display unit 460 can use an LCD, and in this case, the display unit 460 includes an LCD controller, a memory that can store image data, and an LCD display element. When the LCD is embodied as a touch screen, the LCD can be operated as the input unit.

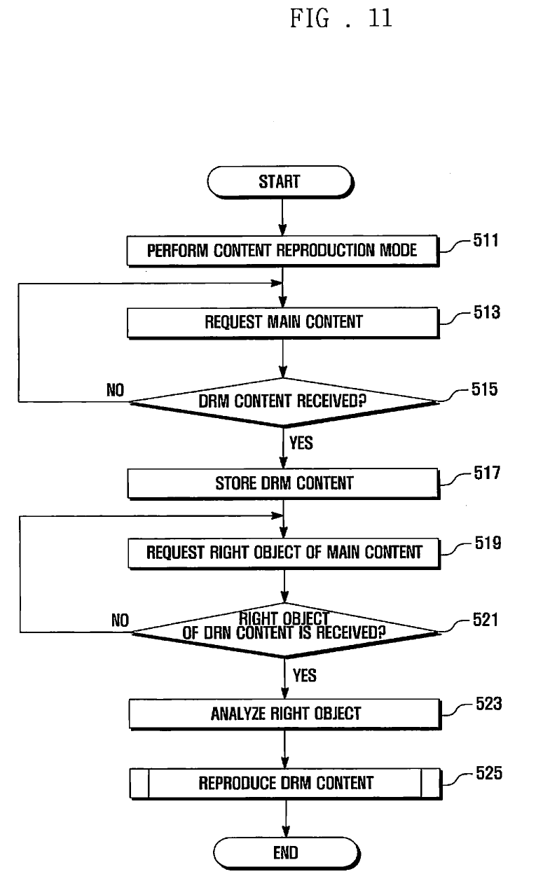

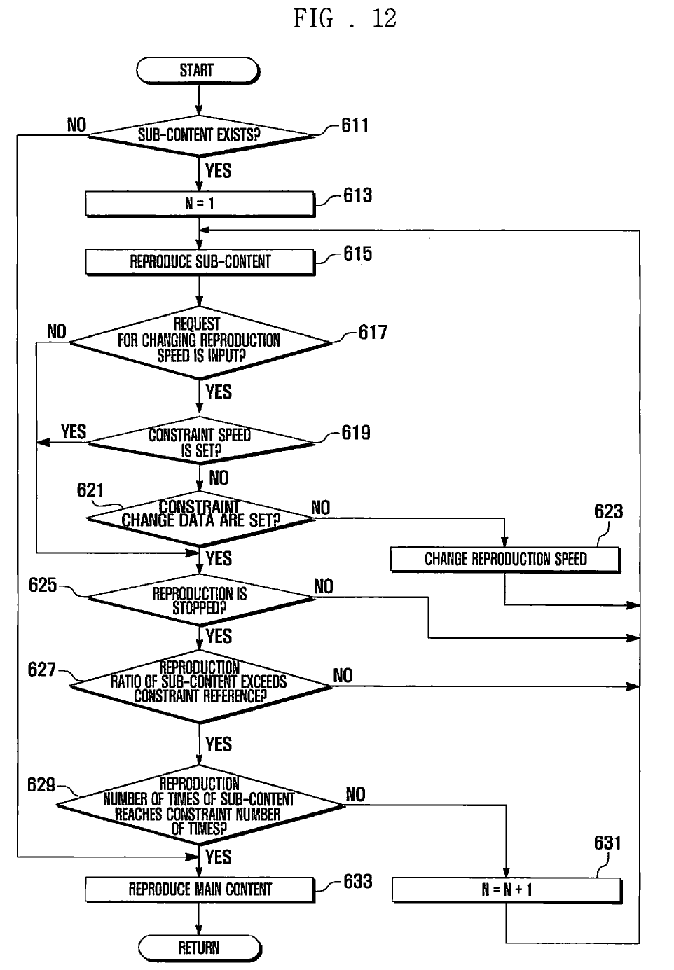

FIG. 11 is a flowchart illustrating a DRM content providing process of the communication terminal 130 of FIG. 10.

Referring to FIG. 11, the controller 440 performs a content reproduction mode in step 511. The controller 440 requests a specific main content to the CI 110 in step 513. The controller 440 determines whether a DRM content is received in step 515. If a DRM content is received, the controller 440 stores the DRM content in step 517. If a DRM content is not received, the process returns to step 513. The controller 440 requests a rights object of the main content to the RI 120 in step 519. The controller 440 determines whether the rights object of the main content is received in step 521. If the rights object of the main content is received, the controller 440 analyzes the rights object in step 523. If the rights object of the main content is not received, the process returns to step 519. The controller 440 reproduces the DRM content in step 525.

FIG. 12 is a flowchart illustrating a process of reproducing a DRM content in the DRM content providing process of FIG. 11.

Referring to FIG. 12, the controller 440 determines whether a sub-content exists in a corresponding DRM content in step 611. If a sub-content exists in a corresponding DRM content, the controller 440 sets the constraint “min count” N of the sub-content to 1 in step 613 and reproduces the sub-content in step 615. If constraint condition information of the rights object stores a constraint “speed”, the controller 440 reproduces the sub-content with a reproduction speed corresponding to the constraint “speed”. For example, as shown in FIG. 7, if the constraint “speed” is set to ‘<speed>1×</speed>’ in a rights object, the controller 440 reproduces the sub-content with one time speed. If constraint condition information of the right object does not store a constraint “speed”, the controller 440 reproduces a sub-content with a reproduction speed corresponding to a preset default speed.

The controller 440 determines whether a request for changing a reproduction speed is input while reproducing the sub-content in step 617. If a request for changing a reproduction speed is input while reproducing the sub-content, the controller 440 determines whether the constraint “speed” is set in the rights object through constraint condition information in step 619. If the constraint “speed” is not set in the rights object, the controller 440 determines whether constraint “Not allowed” is set in the rights object through constraint condition information in step 621. For example, as shown in FIG. 6, the controller 440 determines whether constraint “Not allowed” is set as ‘<Not allowed>FF, skip</Not allowed>’ in the rights object. If constraint “Not allowed” is not set as ‘<Not allowed>FF, skip</Not allowed>’ in the rights object, the controller 440 changes a reproduction speed in step 623 and the process returns to step 615. If constraint “Not allowed” is set in the rights object through constraint condition information, the controller 440 sustains a reproduction speed.

The controller 440 determines whether reproduction is stopped while reproducing the sub-content in step 625. If reproduction is stopped while reproducing the sub-content, the controller 440 determines whether a reproduction ratio of the sub-content exceeds a constraint reference in step 627. For example, as shown in FIG. 8, if a constraint “completed” is set to ‘<completed>70%</completed>’ in the rights object, the controller 440 determines whether a reproduction ratio of the sub-content exceeds 70%. If a reproduction ratio of the sub-content does not exceed a constraint “completed”, the controller 440 determines that reproduction of the sub-content fails and the process returns to step 615. If a reproduction ratio of the sub-content exceeds a constraint “completed”, the controller 440 determines that reproduction of the sub-content is complete and determines whether the reproduction “min count” of the sub-content reaches the constraint number of times in step 629. For example, as shown in FIG. 5, if the constraint “min count” is set to ‘<min count>1</min count>’ in the rights object, the controller 440 determines whether the reproduction number of times of the sub-content reaches 1. If the reproduction number of times of the sub-content does not reach the constraint set in “min count”, the controller 440 increases the reproduction number of times of the sub-content by 1 and the process returns to step 615. If the reproduction number of times of the sub-content does not reach the constraint set in “min count”, the controller 440 reproduces the main content in step 633 and the process returns to the process of providing a DRM content of FIG. 11.

If a sub-content does not exist in a corresponding DRM content at step 611, the controller 440 reproduces the main content and the process returns to the process of providing a DRM content of FIG. 11.

As described above, in a system and method for providing DRM content according to the present invention, reproduction of a sub-content in a communication terminal can be secured through constraint condition information of a rights object. That is, refusal of reproduction of the sub-content can be prevented in the communication terminal. Thereby, in the DRM content providing system, a waste of resources required for providing the sub-content can be suppressed.

Although embodiments of the present invention have been described in detail hereinabove, it should be clearly understood that many variations and modifications of the basic inventive concepts herein described, which may appear to those skilled in the art, will still fall within the spirit and scope of the exemplary embodiments of the present invention as defined in the appended claims.

What is claimed is:

1. A method of providing DRM content, comprising the steps of:
transmitting, by a Content Issuer (CI), when a request for a main content of a communication terminal is input, a DRM content including the main content and a preset sub-content corresponding to the main content to the communication terminal;
transmitting, by a Rights Issuer (RI), a rights object including constraint condition information for securing reproduction of the sub-content to the communication terminal; and
reproducing, by the communication terminal, when the DRM content and the rights object are received, the sub-content by analyzing the right object and reproducing, when reproduction of the sub-content is complete, the main content.

2. The method of claim 1, wherein the rights object comprises:
a context element including a background and an identifier of the rights object;
an agreement element including an identifier of the sub-content and the main content; and
a permission element for permitting reproduction of the sub-content and the main content and containing the constraint condition information.

3. The method of claim 1, wherein the constraint condition information comprises a constraint speed for limiting a reproduction speed of the sub-content in the communication terminal.

4. The method of claim 3, wherein the reproduction process comprises reproducing the sub-content at the constraint speed.

5. The method of claim 1, wherein the constraint condition information includes a constraint indicating a number of times the sub-content should be reproduced in the communication terminal.

6. The method of claim 5, wherein the reproduction process comprises:
counting, when the sub-content is reproduced, the number of times the sub-content is reproduced;
comparing, when reproduction of the sub-content is stopped, the number of times the sub-content is reproduced with the constraint indicating the number of times the sub-content should be reproduced; and
repeatedly reproducing the sub-content, if the number of times the sub-content is reproduced is less than or equal to the constraint indicating the number of times the sub-content should be reproduced, and reproducing the main content, if the number of times the sub-content is reproduced is greater than the constraint indicating the number of times the sub-content should be reproduced.

7. The method of claim 1, wherein the constraint condition information includes a constraint indicating a ratio of sub-content to be reproduced in the communication terminal.

8. The method of claim 7, wherein the reproduction process comprises:
comparing, when reproduction of the sub-content is stopped, a reproduction ratio of the sub-content with the constraint indicating a ratio of sub-content to be reproduced; and
determining, if the reproduction ratio exceeds the constraint indicating a ratio of sub-content to be reproduced, that reproduction of the sub-content is complete and determining, if the reproduction ratio does not exceed the constraint indicating a ratio of sub-content to be reproduced, that reproduction of the sub-content fails.

9. The method of claim 1, wherein the constraint condition information includes constraint for limiting a reproduction speed change of the sub-content in the communication terminal.

10. The method of claim 9, wherein the reproduction process comprises:
determining, when a request for a reproduction speed change of the sub-content is input while reproducing the sub-content, whether the reproduction speed can be changed according to the constraint for limiting a reproduction speed; and
changing the reproduction speed, if the reproduction speed can be changed, the reproduction speed, and sustaining the reproduction speed, if the reproduction speed cannot be changed.

11. A DRM content providing system, comprising:
a Content Issuer (CI) for storing a DRM content including a main content and a sub-content corresponding to the main content and for transmitting, when a request for the main content is input, the DRM content;
a Rights Issuer (RI) for storing a rights object including constraint condition information for securing reproduction of the sub-content in the DRM content and for transmitting, when a request for the right object is input, the rights object; and
a communication terminal for reproducing, when the DRM content and the rights object are received, the sub-content by analyzing the rights object and for reproducing the main content, when reproduction of the sub-content is complete.

12. The DRM content providing system of claim 11, wherein the rights object comprises:
a context element including a background and an identifier of the rights object;
an agreement element including an identifier of the sub-content and the main content; and
a permission element for permitting reproduction of the sub-content and the main content and including the constraint condition information.

13. The DRM content providing system of claim 11, wherein the constraint condition information includes a constraint indicating a speed for limiting a reproduction speed of the sub-content in the communication terminal.

14. The DRM content providing system of claim 13, wherein the communication terminal reproduces the sub-content at the speed indicated in the constraint indicating the speed.

15. The DRM content providing system of claim 11, wherein the constraint condition information includes a constraint indicating a number of times the sub-content should be reproduced in the communication terminal.

16. The DRM content providing system of claim 15, wherein the communication terminal counts, when the sub-content is reproduced, the number of times the sub-content is reproduced, compares, when reproduction of the sub-content is stopped, the number of times the sub-content is reproduced with the constraint indicating a number of times the sub-content should be reproduced, repeatedly reproduces the sub-content, if the number of times the sub-content is reproduced is less than or equal to the constraint indicating a number of times the sub-content should be reproduced, and reproduces the main content, if the number of times the sub-content is reproduced is greater than the constraint indicating a number of times the sub-content should be reproduced.

17. The DRM content providing system of claim 11, wherein the constraint condition information includes a constraint indicating a ratio of sub-content to be reproduced in the communication terminal.

18. The DRM content providing system of claim 17, wherein the communication terminal compares, when reproduction of the sub-content is stopped, a reproduction ratio of the sub-content with the constraint indicating a ratio of sub-content to be reproduced, determines, if the reproduction ratio exceeds the constraint indicating a ratio of sub-content to be reproduced, that reproduction of the sub-content is complete, and determines, if the reproduction ratio does not exceed the constraint indicating a ratio of sub-content to be reproduced, that reproduction of the sub-content fails.

19. The DRM content providing system of claim 11, wherein the constraint condition information comprises constraint for limiting a reproduction speed change of the sub-content in the communication terminal.

20. The DRM content providing system of claim 19, wherein the communication terminal determines, when a request for a reproduction speed change of the sub-content is input while reproducing the sub-content, whether the reproduction speed can be changed according to the constraint for limiting a reproduction speed, changes the reproduction speed, if the reproduction speed can be changed, and sustains the reproduction speed, if the reproduction speed cannot be changed.
